(19) United States
(12) Patent Application Publication
(10) Pub. No.: US 2026/0065136 A1
(43) Pub. Date: Mar. 5, 2026

(54) CLASSIFICATION WITH AUTOMATED MODEL SELECTION, TUNING, AND TRAINING

(71) Applicant: Snowflake Inc., Bozeman, MT (US)

(72) Inventors: Paritosh Aggarwal, San Carlos, CA (US); Boxin Jiang, Sunnyvale, CA (US); Dmytro Krasnoshtan, Sunnyvale, CA (US); Abishek Sridhar, South San Francisco, CA (US); Jay S. Tayade, Redmond, WA (US); Artiom Zayats, Seattle, WA (US)

(21) Appl. No.: 18/823,502

(22) Filed: Sep. 3, 2024

(51) Int. Cl. G06N 20/00

(52) U.S. Cl. CPC G06N 20/00

(57) ABSTRACT

Embodiments of the present disclosure provide techniques for classification with automated model selection, tuning, and training. A processing device receives, from a client, a data query referencing an input data set of a database associated with a virtual warehouse. The processing device allocates an amount of memory of the virtual warehouse to be used to train a machine learning (ML) model based on the input data set and a peak memory estimate, where the peak memory estimate is based on a heuristic. The processing device trains, based on the input data set and the data query, the ML model in the virtual warehouse using the amount of memory.

### TECHNICAL FIELD

The present disclosure relates to database platforms, and particularly to classification with automated model selection, tuning, and training.

### BACKGROUND

Databases are widely used for data storage and access in computing applications. Databases may include one or more tables that include or reference data that can be joined, read, modified, or deleted using queries. Databases can store small or extremely large sets of data within one or more tables. This data can be accessed by various users in an organization or even be used to service public users, such as via a website or an application program interface (API). The large amount of data that can be contained within a database can often be useful for various types of data analytics, which involves the attempt to determine conclusions and/or predictions based on analysis of the information contained in the data.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram depicting an example computing environment in which the methods disclosed herein may be implemented in accordance with some aspects of the present disclosure.

FIG. 2 is a diagram illustrating an example of a computing system for classification with automated model selection, tuning, and training in accordance with some aspects of the present disclosure.

FIG. 3 is a diagram illustrating an example of steps for classification with automated model selection, tuning, and training in accordance with some aspects of the present disclosure.

FIG. 4 is a diagram illustrating an example of training data in accordance with some aspects of the present disclosure.

FIG. 5 is a diagram illustrating an example of resource estimation in accordance with some aspects of the present disclosure.

FIG. 6 is a flow diagram of a method for classification with automated model selection, tuning, and training in accordance with some aspects of the present invention.

FIG. 7 is a block diagram of an example computing device that may perform one or more of the operations described herein in accordance with some aspects of the present invention.

### DETAILED DESCRIPTION

Machine learning (ML) has been increasingly used to perform analysis and prediction on large amounts of data. ML may include, in part, generating ML models via a training process. An ML model may incorporate parameters and hyperparameters. The parameters of the ML model are elements (e.g., weights) of the ML model that are varied as part of the machine learning process (e.g., during training of the machine learning model). Hyperparameters are elements that are associated with the structure/operation of the ML model itself. Hyperparameter tuning is the process of searching for satisfactory and/or optimal values for a set of parameters in ML training algorithms.

A user of a virtual warehouse/virtual warehouse service may wish to perform an ML-based analysis on data (e.g., tabular data) stored in a virtual warehouse. In an example, a user may wish to use ML on customer data to classify customers as either likely to stop using a service or likely to continue using the service (sometimes referred to as “churn”). However, the user may not be familiar with the various nuances of ML techniques (e.g., parameters and hyperparameters, data validation, featurization, modeling, evaluation, etc.). Moreover, while the user may be familiar with data query languages (e.g., structured query language (SQL)), the user may not be familiar with programming languages typically used for ML, such as Python®. While programmatic tools exist that simplify ML for users, such tools may require a user to transfer data stored in the virtual warehouse to other storage (e.g., local storage) in order to train an ML based on the data. Transferring the data from the virtual warehouse to local storage for training and transferring a trained model back to the virtual warehouse may be burdensome on network resources. Furthermore, in some cases, a size of the local storage may not be sufficient to store the data.

Additionally, training an ML model may entail utilizing a relatively large amount of memory of the virtual warehouse. If the virtual warehouse runs out of memory during training of an ML model, the training process may fail, and thus the computing resources used during the training are wasted without producing a usable ML model. Conversely, if a virtual warehouse allocates too much memory for training an ML model, some of the memory remains unused during training, which is inefficient. As such, approaches to estimating a peak memory usage during training of an ML model have been developed in order to prevent the virtual warehouse from running out of memory. In one approach, a virtual warehouse estimates peak memory usage of training an ML model using a simple rule based approach (e.g., based only on a number of rows in training data). However, simple rule based approaches may not accurately estimate peak memory usage. In another approach, a virtual warehouse estimates peak memory usage of training an ML model using a second ML model that is configured to predict peak memory usage. However, training the second ML model to accurately predict peak memory usage may entail training the second ML model using a relatively large training data set, which may not be available. Furthermore, memory factors may change each time a change occurs in code, an algorithm, a model, a bundle, and/or a virtual warehouse sandbox, which may affect the accuracy of the second ML model.

The present disclosure addresses the above and other issues by providing techniques for classification with automated model selection, tuning, and training. With more particularity, the present disclosure provides for techniques that enable a client (i.e., a client device) operated by a user (e.g., an analyst without ML expertise) to cause a virtual warehouse to train an ML model (e.g., a classification model, such as a gradient boosted decision tree classification model) based on data of the user (i.e., training data) in the virtual warehouse via a single data query (e.g., a SQL query). The single data query may cause a virtual warehouse to perform steps of ML training (e.g., validation, resource estimation, featurization, modeling, etc.) without additional input from the client and without transferring data of the user outside of the virtual warehouse. As such, the present disclosure may reduce/eliminate usage of network resources associated with transferring training data from a virtual warehouse to local storage and transferring a trained model from the local storage to the virtual warehouse. In some aspects, the virtual warehouse may cause visualizations to be presented on the client device so that the user may become aware of factors affecting the performance of the ML model. Additionally, the present disclosure describes estimating a peak memory usage of a virtual warehouse during a training process based on a heuristic. The heuristic may be based at least in part on a first set of factors (e.g., a number of rows of training data), a second set of factors (the number of rows, a number of columns of training data, and an input memory amount), and a third set of factors (the number of rows, the number of columns, the input memory amount, and a number of classes that are to be classified by the ML model). Estimating the peak memory usage based on the heuristic may simultaneously enable accurate estimation of peak memory usage while avoiding having to gather and process large amounts of training data to train an ML model to estimate peak memory usage used for training ML models.

In an example, a processing device receives, from a client, a data query referencing an input data set of a database associated with a virtual warehouse. The processing device allocates an amount of memory of the virtual warehouse to be used to train an ML model based on the input data set and a peak memory estimate, wherein the peak memory estimate is based on a heuristic. In an example, the processing device trains, based on the input data set and the data query, the ML model in the virtual warehouse using the amount of memory. Vis-à-vis receiving, from a client, a data query referencing an input data set of a database associated with a virtual warehouse, the processing device enables the virtual warehouse to train an ML model (e.g., a classification model, such as a gradient boosted decision tree classification model) based on data of the user (i.e., training data) in the virtual warehouse via a single data query (e.g., a SQL query). The single data query may cause a virtual warehouse to perform steps of ML training (e.g., validation, resource estimation, featurization, modeling, etc.) without additional input from the client device and without transferring data of the user outside of the virtual warehouse. As such, the present disclosure may reduce/eliminate usage of network resources associated with transferring training data from a virtual warehouse to local storage and transferring a trained model from the local storage to the virtual warehouse. Furthermore, vis-à-via allocating an amount of memory of the virtual warehouse to be used to train an ML model based on the input data set and a peak memory estimate, wherein the peak memory estimate is based on a heuristic (e.g., a heuristic including a first set of factors including a number of rows of the input data set, a second set of factors including the number of rows of the input data set, a number of columns of the input data set, and an amount of input memory, and a third set of factors including the number of rows of the input data set, the number of columns of the input data set, the amount of the input memory, and a number of classes of the input data set), the processing device may simultaneously enable accurate estimation of peak memory usage while avoiding having to gather and process large amounts of training data to train an ML model to estimate peak memory usage used for training ML models.

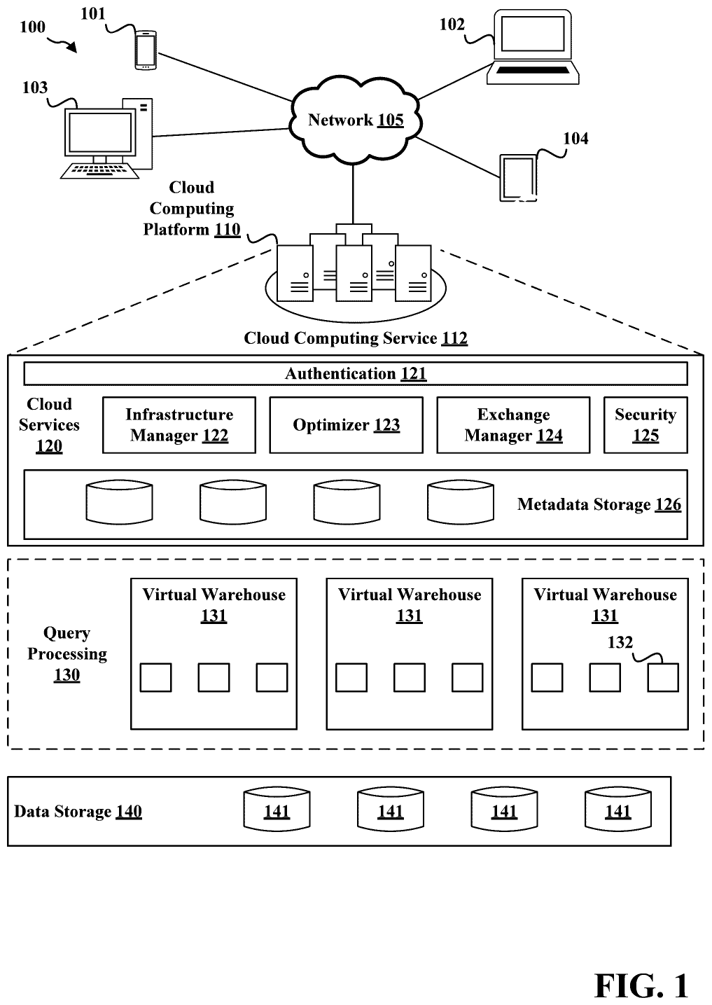

FIG. 1 is a block diagram depicting an example computing environment 100 in which the methods disclosed herein may be implemented in accordance with some aspects of the present disclosure. In particular, a cloud computing platform 110 may be implemented, such as Amazon Web Services™ (AWS), Microsoft Azure™, Google Cloud™, or the like. The cloud computing platform 110 provides computing resources and storage resources that may be acquired (purchased) or leased and configured to execute applications and store data.

The cloud computing platform 110 may host a cloud computing service 112 that facilitates storage of data on the cloud computing platform 110 (e.g., data management and access) and analysis functions (e.g., SQL queries, analysis), as well as other computation capabilities (e.g., secure data sharing between users of the cloud computing platform 110). The cloud computing platform 110 may include a three-tier architecture: data storage 140, query processing 130, and cloud services 120.

The data storage 140 may facilitate the storing of data on the cloud computing platform 110 in one or more cloud databases 141. The data storage 140 may use a storage service such as Amazon S3™ to store data and query results on the cloud computing platform 110. In particular embodiments, to load data into the cloud computing platform 110, data tables may be horizontally partitioned into large, immutable files which may be analogous to blocks or pages in a traditional database system. Within each file, the values of each attribute or column are grouped together and compressed using a scheme sometimes referred to as hybrid columnar. Each table has a header which, among other metadata, contains offsets of each column within the file.

In addition to storing table data, the data storage 140 facilitates the storage of temporary data generated by query operations (e.g., joins), as well as data contained in large query results. This may allow the cloud computing platform 110 to compute large queries without out-of-memory or out-of-disk errors. Storing query results this way may simplify the query processing 130 as it removes the need for server-side cursors found in traditional database systems.

The query processing 130 may handle query execution within elastic clusters of virtual machines, referred to herein as virtual warehouses or data warehouses. Thus, the query processing 130 may include one or more virtual warehouses 131, which may also be referred to herein as data warehouses. The virtual warehouses 131 may be one or more virtual machines operating on the cloud computing platform 110. The virtual warehouses 131 may be compute resources that may be created, destroyed, or resized at any point, on demand. This functionality may create an “elastic” virtual warehouse that expands, contracts, or shuts down according to needs of a user. Expanding a virtual warehouse involves generating one or more compute nodes 132 to a virtual warehouse 131. Contracting a virtual warehouse involves removing one or more compute nodes 132 from a virtual warehouse 131. More compute nodes 132 may lead to faster compute times compared to less compute nodes 132. For example, a data load which takes fifteen hours on a system with four compute nodes might take only two hours with thirty-two compute nodes.

The cloud services 120 may be a collection of services that coordinate activities across the cloud computing service 112. The cloud services 120 tie together some or all of the different components of the cloud computing service 112 in order to process user requests, from login to query dispatch. The cloud services 120 may operate on compute instances provisioned by the cloud computing service 112 from the cloud computing platform 110. The cloud services 120 may include a collection of services that manage virtual warehouses, queries, transactions, data exchanges, and metadata associated with such services, such as database schemas, access control information, encryption keys, and usage statistics. The cloud services 120 may include, but are not limited to, an authentication engine 121, an infrastructure manager 122, an optimizer 123, an exchange manager 124, a security engine 125, and metadata storage 126.

User devices 101-104 (including a user device 101, a user device 102, a user device 103, and a user device 104), such as laptop computers, desktop computers, mobile phones, tablet computers, cloud-hosted computers, cloud-hosted serverless processes, or other computing processes or devices may be used to access the virtual warehouse 131 or cloud service 120 by way of a network 105, such as the Internet or a private network.

In the description below, actions are ascribed to users, particularly consumers and providers. Such actions shall be understood to be performed with respect to the user devices 101-104 operated by such users. For example, notification to a user may be understood to be a notification transmitted to user devices 101-104, an input or instruction from a user may be understood to be received by way of the user devices 101-104, and interaction with an interface by a user shall be understood to be interaction with the interface on the user devices 101-104. In addition, database operations (joining, aggregating, analysis, etc.) ascribed to a user (a data consumer or a data provider) shall be understood to include performing of such actions by the cloud computing service 112 in response to an instruction from the user.

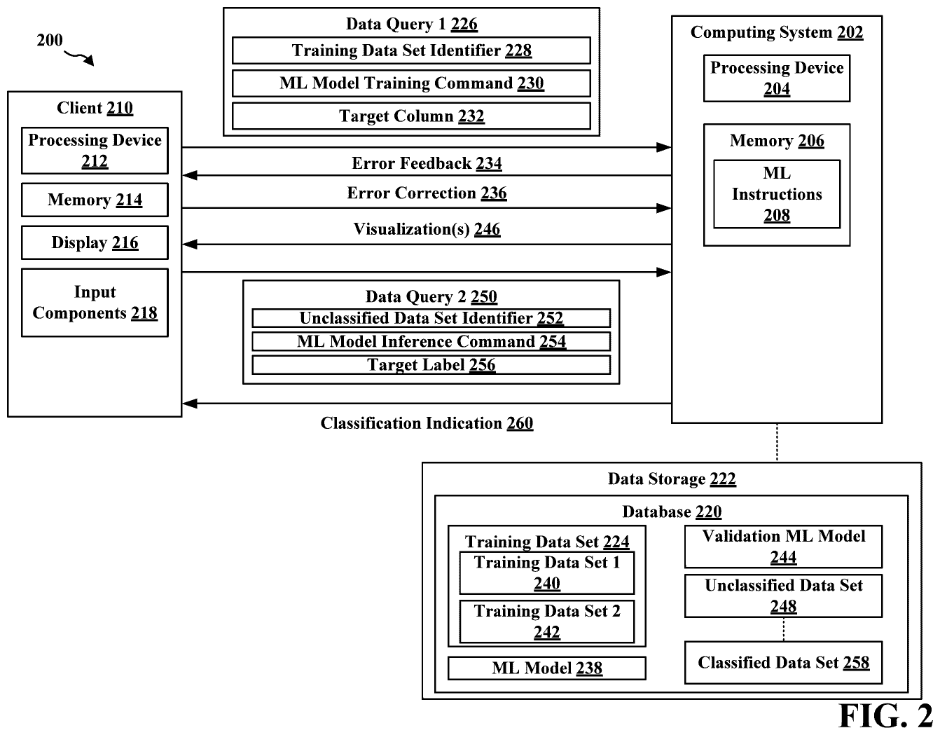

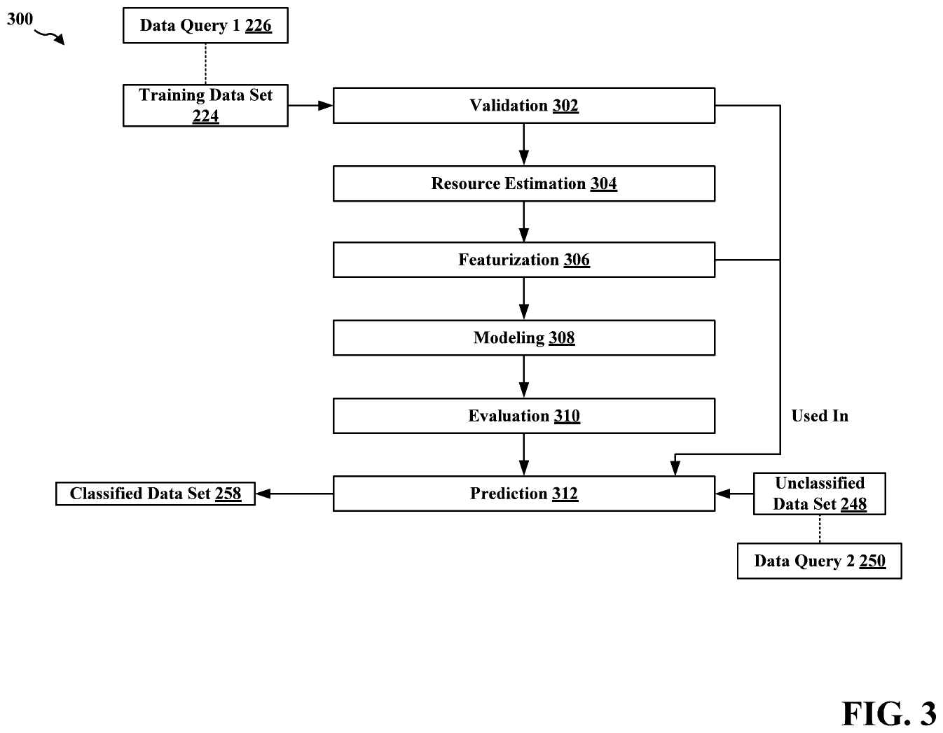

FIG. 2 is a diagram 200 illustrating an example of a computing system 202 for classification (e.g., multiclass classification) with automated model selection, tuning, and training in accordance with some aspects of the present disclosure. In an example, the computing system 202 may be or include the cloud computing platform 110. The computing system 202 includes a processing device 204 and memory 206. The processing device 204 may be operatively coupled to the memory 206. The memory 206 stores ML instructions 208 that, when executed by the processing device 204, cause the processing device 204 to perform various methodologies described herein for automated model selection, tuning, and training. FIG. 3 is a diagram 300 illustrating an example of steps for classification (e.g., multiclass classification) with automated model selection, tuning, and training in accordance with some aspects of the present disclosure. Referring jointly now to FIG. 2 and FIG. 3, the ML instructions 208, when executed by the processing device 204, cause the processing device 204 to perform validation 302, resource estimation 304, featurization 306, modeling 308, evaluation 310, and prediction 312, each of which will be described in greater detail below. In some aspects, each of the validation 302, the resource estimation 304, the featurization 306, the modeling 308, the evaluation 310, and the prediction 312 may be implemented by separate pipelines.

It is contemplated that a client 210 (i.e., a client device, such as a desktop computing device, a laptop computing device, a tablet computing device, a smartphone, etc.) is operated by a user. The client 210 may be or include the user device 101. The client 210 includes a processing device 212 and memory 214. The processing device 212 is operatively coupled to the memory 214. The client 210 may also include a display 216 that may present graphical data to the user. The client 210 may further include input components 218 (e.g., a mouse, a keyboard, a trackpad, a scroll wheel, a touchscreen, a microphone, etc.) that enable the client 210 to receive input from the user.

It is further contemplated that the user is associated with data (referred to hereafter as a training data set 224) stored in a database 220 (e.g., a SQL database) in data storage 222 associated with the computing system 202. In an example, the database 220 may be associated with an account of the user with the computing system 202. The training data set 224 may be tabular data (explained in greater detail below) in which data is organized according to rows and columns. In some aspects, the training data set 224 may be or include a table, a view, or a query reference. In an example, the training data set 224 may include details of customers of an organization to which the user belongs.

In some aspects, the data storage 222 may be part of the computing system 202. In some aspects, the data storage 222 may be separate from the computing system 202. In some aspects, the data storage 222 may be part of or associated with a virtual warehouse, such as the virtual warehouse 131. In some aspects, the data storage 222 may be part of or associated with a database platform. In some aspects, the data storage 222 may be or include the data storage 140 and the database 220 may be or include the one or more cloud databases 141.

The client 210 may receive, via the input components 218, a first data query 226 as input from the user. In an example, the first data query 226 is a SQL query. The first data query 226 may include a training data set identifier 228. The training data set identifier 228 may identify/reference the training data set 224 in the database 220 of the data storage 222. The first data query 226 may include an ML model training command 230. The ML model training command 230 may indicate the computing system 202 to train a classification model. The first data query 226 may include a target column 232 of the training data set 224. The target column 232 includes labels (i.e., classes) that are to be predicted via the to-be-generated ML model. In some aspects, the labels include two labels (i.e., two classes). In some aspects, the labels include three or more labels (i.e., three classes).

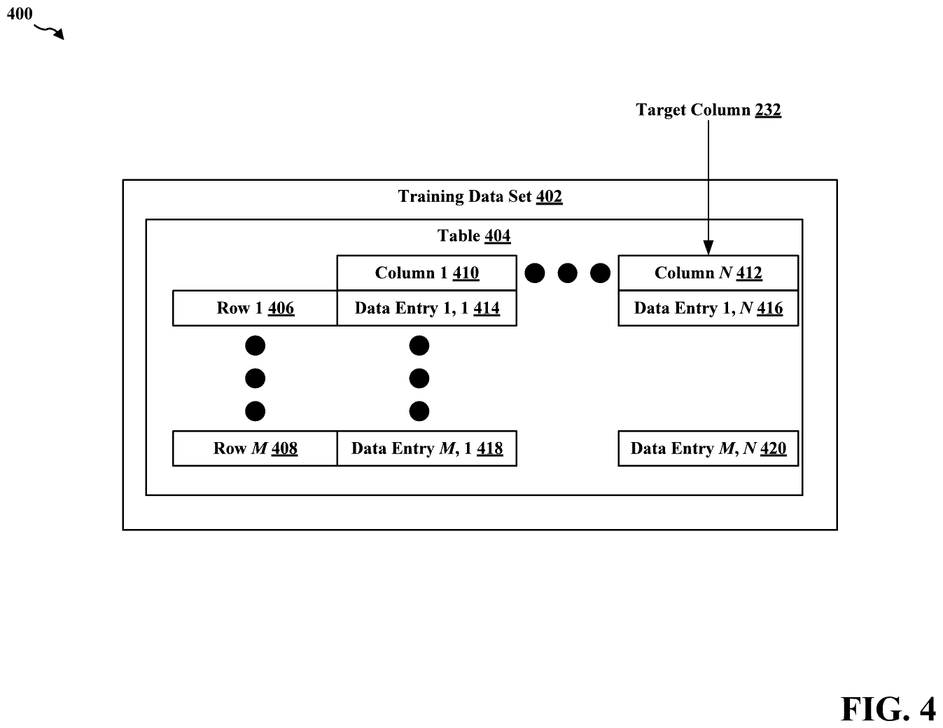

FIG. 4 is a diagram 400 illustrating an example of a training data set 402 in accordance with some aspects of the present disclosure. In an example, the training data set 402 may be or include the training data set 224. The training data set 402 includes a table 404. The table 404 may include a first row 406 and an Mth row 408, where M is an integer greater than one. Thus, the table 404 may include a plurality of rows 406-408. The table 404 may also include a first column 410 and an Nth column 412, where N is an integer greater than one. Thus, the table 404 may include a plurality of columns 410-412. The table 404 may thus be referred to as an M row x N column table. In an example, each row in the plurality of rows 406-408 is assigned to a different customer. For instance, the first row 406 may be assigned to a first customer and the Mth row 408 may be assigned to an Mth customer. In an example, a number of rows in the plurality of rows 406-408 ranges from 1000 rows to 3.25 million rows. In an example, each column in the plurality of columns 410-412 is assigned to a different attribute. In an example, the first column 410 is assigned to a purchase frequency of a service, a second column (not depicted in FIG. 4) in the plurality of columns 410-412 is assigned to a customer engage metric (e.g., a number of views of a website) of the service, and the Nth column 412 is assigned to whether or not a customer continues to use the service. In an example, a number of columns in the plurality of columns 410-412 ranges from 5-100.

The table 404 includes data entries associated with rows and columns of the table. In an example, data entry 1, 1 414 (corresponding to the first row 406 and the first column 410) includes information pertaining to a purchase frequency of the service by a first customer. Data entry 1, 2 (corresponding to the first row and the second column, not depicted in FIG. 4) includes information pertaining to the customer engagement metric of the first customer. Data entry 1, N 416 (corresponding to the first row 406 and the Nth column 412) includes information indicating whether the first customer currently uses the service. In an example, data entry M, 1 418 (corresponding to the Mth row 408 and the first column 410) includes information pertaining to a purchase frequency of the service by a second customer. Data entry M, 2 (corresponding to the Mth row 408 and the second column, not depicted in FIG. 4) includes information pertaining to the customer engagement metric of the second customer. Data entry M, N 420 (corresponding to the Mth row 408 and the Nth column 412) includes information indicating whether the second customer currently uses the service. In an example, a data query (e.g., the first data query 226) specifies that that the Nth column 412 is the target column 232, that is, an ML model is to be generated that predicts whether or not a customer will continue to use the service (sometimes referred to as churn prediction).

Referring back to FIG. 2 and FIG. 3, the client 210 may transmit the first data query 226 to the computing system 202 by way of a network (e.g., the network 105). The computing system 202 receives the first data query 226 by way of the network. In some aspects, the first data query 226 may cause the computing system 202 to generate an ML model 238 without further input from the client 210 and using the native syntax of the database 220, that is, the first data query 226 may cause the computing system 202 to automatically perform each of the validation 302, the resource estimation 304, the featurization 306, the modeling 308, and the evaluation 310 without further input from the client 210. The computing system 202 may obtain or retrieve or access the training data set 224 from the database 220 of the data storage 222 based on the first data query 226.

The computing system 202 may perform the validation 302 to ensure that the training data set 224 is in a format that is able to be accepted by a training function. In some aspects, the computing system 202 may perform some or all of the validation 302 (e.g., validation that requires a relatively low amount of compute resources) via Python® code. In some aspects, the computing system 202 may perform some or all of the validation 302 (e.g., validation that requires a relatively high amount of compute resources) via data queries, such as SQL queries, directed towards database 220. The validation 302 may include column-level type validation, data size validation, and/or an entire data set validation to ensure that the training data set 224 is compatible with classification. Column-level type validation may include determining that a type of columns of the training data set 224 are compatible with the training function. Data size validation may include determining that a size of the training data set 224 is compatible with the training function. Entire data set validation may include determining that an entirety of the data set is compatible with the training function.

In some aspects, the computing system 202 may determine that some or all of the validation 302 has failed. In an example, a data type of a column in the training data set 224 may not be supported by the training function. The computing system 202 may transmit, via the network, error feedback 234 to the client 210. The client 210 may present the error feedback 234 on the display 216. The error feedback 234 may indicate that an error occurred in the validation 302. The error feedback 234 may include a suggestion to fix the error. In an example, the error may be converting the data type of the column into a data type supported by the training function. Based on the error feedback 234, the client 210 may receive an error correction 236 as input from the user via the input components 218. The client 210 may transmit the error correction 236 to the computing system 202 via the network. The computing system 202 may receive the error correction 236 via the network. The computing system 202 may perform the error correction 236 to the training data set 224 such that the data type of the column is compatible with the training function.

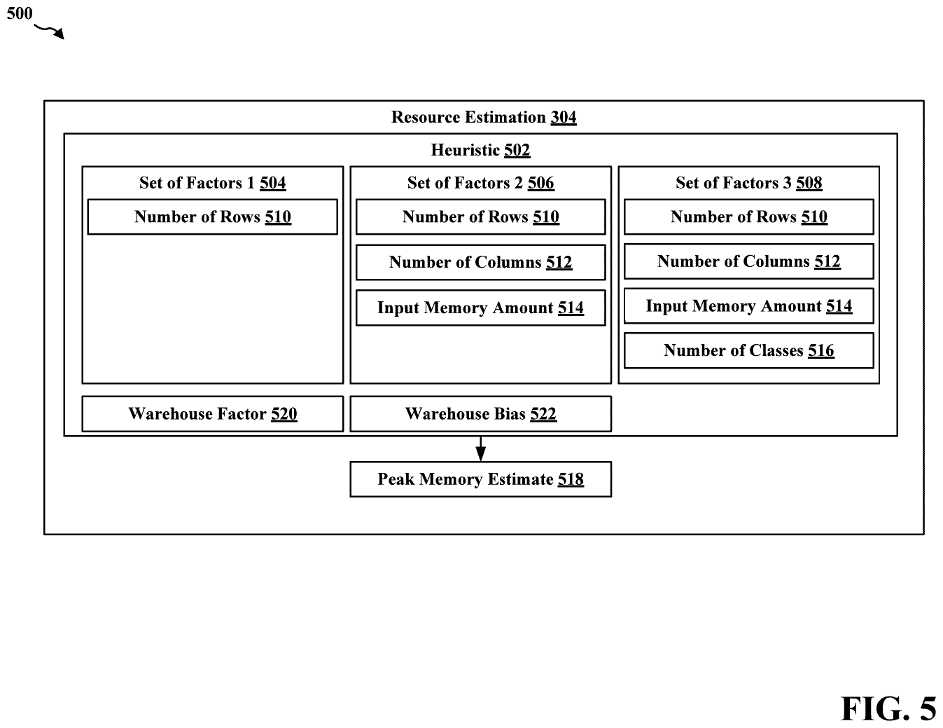

Subsequent to performing the validation 302, the computing system 202 may perform the resource estimation 304 on the (validated) training data set 224. The computing system 202 may estimate a peak amount of memory usage for the modeling 308 during the resource estimation 304. During the modeling 308, the computing system 202 may allocate an amount of memory that is greater than or equal to the estimate of the peak amount of memory usage in order to prevent the computing system 202 from running out of memory during training. In some aspects, the computing system 202 may perform model routing based on the resource estimation 304, that is, the computing system 202 may select an ML model to train or an ML modeling technique based on an output of the resource estimation 304. FIG. 5 is a diagram 500 illustrating an example of the resource estimation 304 in accordance with some aspects of the present disclosure. The computing system 202 may perform the resource estimation 304 based on a heuristic 502. The heuristic 502 may be based on a first set of factors 504, a second set of factors 506, and a third set of factors 508.

The first set of factors 504 may be based on a number of rows 510 of the training data set 224. In some aspects, the computing system 202 may compute a contribution of the first set of factors 504 to the estimate of the peak amount of memory usage based on the number of rows 510. In some aspects, the contribution may be weighted differently depending on whether or not the number of rows 510 exceeds or equals a threshold number of rows (e.g., 2*10⁶ rows).

The second set of factors 506 may be based on the number of rows 510 of the training data set 224, a number of columns 512 of the training data set 224, and an input memory amount 514 of the training data set 224 (i.e., an amount of memory of the training data set 224 in kilobytes, megabytes, gigabytes, etc.). In some aspects, the computing system 202 may compute a contribution of the second set of factors to the estimate of the peak amount of memory usage based on the number of rows 510, the number of columns 512, and the input memory amount 514. In some aspects, computing the contribution of the second set of factors 506 may include computing a first slope and an intercept. The first slope may be based on the number of rows 510 and an average size of a column per a second number of rows (e.g., 1000). The intercept may be based on an intercept base and an intercept factor. The intercept base may be based on the average size of the column per the second number of rows and the intercept factor may be based on the number of rows 510. The contribution of the second set of factors 506 may be based on the first slope, the number of columns 512, the number of rows 510, and the intercept.

The third set of factors 508 may be based on the number of rows 510 of the training data set 224, the number of columns 512 of the training data set 224, the input memory amount 514 of the training data set 224, and a number of classes 516 (i.e., a number of possible labels that a row can be labeled with, such as two, three, four, etc.). In some aspects, the computing system 202 may compute a contribution of the third set of factors 508 to estimate the peak amount of memory usage based on the number of rows 510 of the training data set 224, the number of columns 512 of the training data set 224, the input memory amount 514, and the number of classes 516. In some aspects, computing the contribution of the third set of factors 508 may include computing a second slope. The second slope may be based on the number of rows 510, the number of columns 512, the input memory amount 514, and an average size of a column per a second number of rows (e.g., 1000). The contribution of the third set of factors 508 may be based on the second slope, the number of classes 516, and the number of rows 510.

The computing system 202 may generate a peak memory estimate 518 (i.e., an estimated peak amount of memory to be used during the modeling 308) based on the heuristic 502, that is, the computing system 202 may generate the peak memory estimate 518 based on the first set of factors 504, the second set of factors 506, and the third set of factors 508. In some aspects, the computing system 202 generates the peak memory estimate 518 based on a sum of the contribution of the first set of factors 504, the contribution of the second set of factors 506, and the contribution of the third set of factors 508. In some aspects, the computing system 202 generates the peak memory estimate 518 additionally based on a warehouse factor 520 and a warehouse bias 522. The warehouse factor 520 and the warehouse bias 522 may account for characteristics of a warehouse (e.g., the virtual warehouse 131) used in training the ML model 238. In some aspects, the computing system 202 may generate the peak memory estimate 518 according to equation (I) below.

Peak Mem.Usage=(Cont. from Set 1+Cont. from Set 2+Contr. from Set 3)*WH_{Factor}+WH_{bias} (I)

In equation (I) above, “Peak Mem. Usage” corresponds to peak memory estimate 518, “Cont. from Set 1” corresponds to the contribution of the first set of factors 504, “Cont. from Set 2” corresponds to the contribution of the second set of factors 506, “Cont. from Set 3” corresponds to the contribution of the third set of factors 508, “WH_{Factor}” corresponds to the warehouse factor 520, and “WHbius” corresponds to the warehouse bias 522.

In some aspects, the computing system 202 determines that the peak memory estimate 518 is greater than or equal to a threshold associated with a virtual warehouse (e.g., the virtual warehouse 131). In such aspects, the computing system 202 selects a subset of the training data set 224. The computing system 202 may perform the steps described above with respect to the resource estimation 304 using the subset of the training data set 224 to generate a second peak memory estimate for the subset of the training data set 224. If the second peak memory estimate is less than the threshold associated with the virtual warehouse, the computing system 202 may use the second peak memory estimate to allocate memory during the modeling 308 and the computing system 202 may train the model using the subset of the training data set 224.

Referring back to FIG. 2 and FIG. 3, subsequent to the performing the resource estimation 304, the computing system 202 may perform the featurization 306. Featurization may refer to creating and/or transforming some or all of the training data set 224 to create features that facilitate ML training. In an example, the featurization 306 may include dropping high cardinality or no variance features in the training data set 224, imputing missing values into the training data set 224, generating additional features for the training data set 224, transforming and encoding (e.g., one-hot encoding), creating word embeddings, and/or generating a cluster distance. In some aspects, during the featurization 306, the computing system 202 may test each feature for correlation with a label (i.e., a class that is to be predicted) to eliminate noise from the (to-be-generated) ML model. In some aspects, the (to-be-generated) ML model may support categorical features, numerical features, timestamp features, and/or logical (i.e., Boolean) features. In some aspects, the computing system 202 performs the featurization for the numerical features and the logical features using Python® libraries. The computing system 202 may present results of the testing to the user during the evaluation 310.

Subsequent to performing the featurization 306, the computing system 202 may perform the modeling 308 in order to train an ML model 238 based on the (validated and featurized) training data set 224. The computing system 202 trains the ML model 238 to classify data according to labels of the target column 232. For instance, if the target column 232 includes entries that specify “leave” or “stay” as part of churn prediction, the computing system 202 may train the ML model 238 to classify the data as “leave” or “stay.” If the ML model 238 is a binary classifier, the computing system 202 may train the ML model 238 using an area-under-the-curve loss function. If the ML model 238 is a multi-class classifier, the computing system 202 may train the ML model 238 using a logistic loss function. The computing system 202 may allocate an amount of memory for the modeling (e.g., for training the ML model 238) based on a peak amount of memory estimated (i.e., the peak memory estimate 518) during the resource estimation 304. The computing system 202 may train the ML model 238 using the allocated amount of memory. In some aspects, the ML model 238 is initially a pre-trained model (e.g., a pre-trained gradient boosted decision tree) customized to deliver high performance on a set of benchmarks. The modeling 308 may adjust parameters of the pre-trained model using the (validated and featurized) training data set 224 to generate the ML model 238. In some aspects, the computing system 202 may adjust parameters of the ML model 238 using information from the validation 302 to enhance a quality of the ML model 238. The computing system 202 may store the ML model 238 as part of a schema of the database 220 in the data storage 222. The ML model 238 includes learned parameters (e.g., learned weights) that are based on the training process. The ML model 238 may also include hyperparameters.

Subsequent to performing the modeling 308, the computing system 202 may perform the evaluation 310. The evaluation 310 may enable the user to quickly see an estimate of how the ML model 238 (trained during the modeling 308) performs in a real-world use case. The computing system 202 may partition the (validated and featurized) training data set 224 into a first training data set 240 and a second training data set 242. In some aspects, the computing system 202 may partition the (validated and featurized) training data set 224 into the first training data set 240 and the second training data set 242 based on a sampling method (e.g., a stratified sampling method or a random sampling method). In some aspects, the computing system 202 may select the sampling method based on characteristics of the training data set 224. The computing system 202 may train a validation ML model 244 based on the first training data set 240 (and not the second training data set 242) in a manner similar to that described above with respect to the modeling 308.

The computing system may then test performance of the validation ML model 244 using the second training data set 242. For instance, the computing system may provide the second training data set 242 as input to the validation ML model 244, and the validation ML model 244 may output classifications for the second training data set 242 based on learned parameters (e.g., learned weights) of the validation ML model 244 and the input. The computing system 202 may compare the classifications (i.e., the labels) output by the validation ML model 244 to classifications (i.e., labels) in the second training data set 242 to evaluate performance of the validation ML model 244.

The computing system 202 may generate visualization(s) 246 (or data views) based on the performance of the validation ML model 244. The visualization(s) 246 (or the data views) may include graphical information that helps the user to understand performance of the validation ML model 244 quantitatively. In some aspects, the visualization(s) 246 (or the data views) may include indications of which features (e.g., which columns) were important to performance of the validation ML model 244. The computing system 202 may transmit the visualization(s) 246 (or data views) to the client 210 via the network. The client 210 may receive the visualization(s) 246 (or data views) from the computing system 202 via the network. The client 210 may present the visualization(s) 246 (or data views) to the user on the display 216.

Subsequently, it is contemplated that the user (or another user) wishes to classify an unclassified data set 248. In an example, the unclassified data set 248 includes tabular data including rows and columns. In the example, the unclassified data set 248 does not include a column corresponding to the target column 232 in the training data set 224 or the unclassified data set 248 includes a column corresponding to the target column 232, but the column is not yet populated with data. In an example, the unclassified data set 248 is similar to the training data set 402, but does not include a column corresponding to the Nth column 412.

The client 210 (or another client) may receive, via the input components 218, a second data query 250 as input from the user (or another user). In an example, the second data query 250 is a SQL query. The second data query 250 may include an unclassified data set identifier 252. The unclassified data set identifier 252 may identify/reference the unclassified data set 248 in the database 220 of the data storage 222. The second data query 250 may include an ML model inference command 254. The ML model inference command 254 may indicate the computing system 202 performance inference using the ML model 238. The second data query 250 may include a target label 256 that is to be predicted for the unclassified data set 248. The target label 256 may correspond to the target column 232. The client 210 (or another client) may transmit the second data query 250 to the computing system 202 via the network. The computing system 202 may receive the second data query 250 from the client via the network.

The computing system 202 may perform the prediction 312 based on the second data query 250. The computing system may obtain/retrieve/access the unclassified data set 248 based on the unclassified data set identifier 252 of the second data query 250. The computing system 202 may perform the validation 302 and/or the featurization 306 on the unclassified data set 248 in order for the unclassified data set 248 to be in a state that is accepted by the ML model 238. The computing system 202 may provide the (validated and featurized) unclassified data set 248 as input to the ML model 238. The ML model 238 may assign labels to the (validated and featurized) unclassified data set 248 based on learned parameters of the ML model 238 and the (validated and featurized) unclassified data set 248. In an example involving churn, for each customer represented in each row of the unclassified data set 248, the ML model 238 assigns a “leave” or “stay” label. In some aspects, the computing system generates a new column in the unclassified data set 248 that includes the labels, thereby generating a classified data set 258. In some aspects in which the unclassified data set 248 includes a blank column for the labels, the computing system may populate the blank column with the labels, thereby generating the classified data set 258.

In some aspects, during the prediction 312, the computing system may distribute processing of the second data query 250 to a plurality of compute nodes of a virtual warehouse (e.g., the virtual warehouse 131) in order to process the second data query in parallel to provide faster results for the second data query 250. For instance, each of the compute nodes may host an instance of the ML model 238, and each of the compute nodes may execute their respective instance of the ML model 238 on a respective portion of the unclassified data set 248.

In some aspects, concurrently with or subsequent to generating the classified data set 258, the computing system 202 may transmit a classification indication 260 to the client 210 (or another client) via the network. The classification indication 260 may indicate a label assigned to each row of the unclassified data set 248. In an example, the classification indication 260 may include an identifier of each customer represented in the unclassified data set 248 and a label indicating whether the ML model 238 predicted that the customer would continue with the service or leave the service. The client 210 (or another client) may receive the classification indication 260 from the client 210 via the network. The client 210 (or another client) may present the classification indication 260 to the user via the display 216.

In some aspects, the ML model 238 is associated with a first version of the virtual warehouse 131. Subsequently, the virtual warehouse 131 is updated to a second version. The ML model 238 remains compatible with the virtual warehouse 131 despite the virtual warehouse 131 operating based on the second version and not the first version.

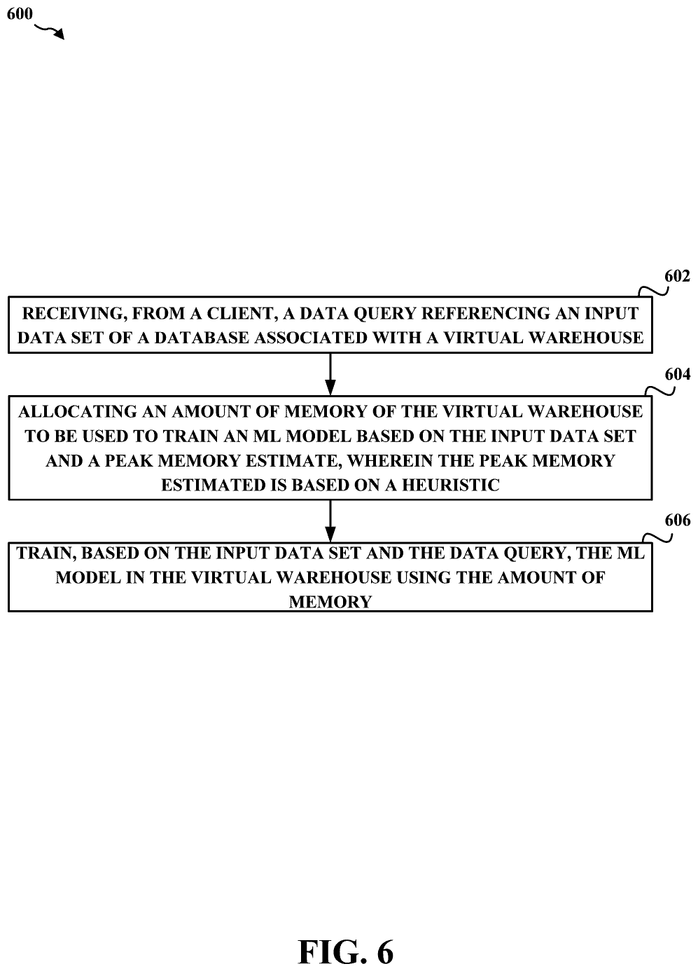

FIG. 6 is a flow diagram of a method 600 for classification (e.g., multiclass classification) with automated model selection, tuning, and training in accordance with some embodiments of the present disclosure. The method 600 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some aspects, the method 600 may be performed by the processing device 204 or the processing device 702. In some aspects, the method may be performed by a virtual warehouse. In some aspects, the method may be performed by the computing system 202.

At block 602, a processing device receives, from a client, a data query referencing an input data set of a database associated with a virtual warehouse. In an example, the client may be or include the client 210. In an example, the data query may be or include the first data query 226. In an example, the input data set may be or include the training data set 224 or the training data set 402. In an example, the database may be or include the database 220. In an example, the virtual warehouse may be or include the virtual warehouse 131.

At block 604, the processing device allocates an amount of memory of the virtual warehouse to be used to train an ML model based on the input data set and a peak memory estimate, where the peak memory estimate is based on a heuristic. In an example, the ML model may be or include the ML model 238. In an example, the peak memory estimate may be or include the peak memory estimate 518. In an example, the memory may be or include the memory 206. In an example, the heuristic may be or include the heuristic 502. In an example, allocating the amount of memory may be associated with the resource estimation 304 and the modeling 308.

At block 606, the processing devices trains, based on the input data set and the data query, the ML model in the virtual warehouse using the amount of memory. In an example, training the ML model may correspond to the modeling 308.

In some aspects, the data query may be a SQL query, and allocating the amount of memory and training the ML model may be based on the SQL query. In an example, the first data query 226 may be a SQL query.

In some aspects, the ML model may be a classification model trained to classify a data set. In an example, the ML model 238 may be a classification model trained to classify a data set.

In some aspects, the processing device may validate, based on the data query, the input data set, and training the ML model may be based on the validated input data set. In an example, the aforementioned aspect may correspond to the validation 302.

In some aspects, validating the input data set may include performing a set of validation steps on the input data set, and the processing device may determine that a validation step in the set of validation steps has failed. In an example, the aforementioned aspect may correspond to the validation 302.

In some aspects, the processing device may transmit, to the client, an indication of the failed validation step. In an example, the aforementioned aspect may correspond to the validation 302. In an example, the indication of the failed validation step may be or include the error feedback 234.

In some aspects, the processing device may receive, from the client, an indication of a correction to the input data set based on the indication of the failed validation step. In an example, the aforementioned aspect may correspond to the validation 302. In an example, the indication of the correction may be or include the error correction 236.

In some aspects, the processing device may re-perform the validation step on the corrected input data set. In an example, the aforementioned aspect may correspond to the validation 302.

In some aspects, validating the input data set may include at least one of: validating column types of the input data set, validating a size of the input data set, or validating an entirety of the input data set. In an example, the aforementioned aspect may correspond to the validation 302.

In some aspects, the processing device may generate the peak memory estimate based on the heuristic, where the heuristic may include a first set of factors comprising a number of rows of the input data set, a second set of factors comprising the number of rows of the input data set, a number of columns of the input data set, and an amount of input memory, and a third set of factors comprising the number of rows of the input data set, the number of columns of the input data set, the amount of the input memory, and a number of classes of the input data set. In an example, the first set of factors may be or include the first set of factors 504, the second set of factors may be or include the second set of factors 506, and the third set of factors may be or include the third set of factors 508. In an example, the aforementioned aspect may correspond to the resource estimation 304.

In some aspects, generating the peak memory estimate may be based on a combination of the first set of factors, the second set of factors, and the third set of factors. In an example, the aforementioned aspect may correspond to the resource estimation 304.

In some aspects, the processing device may determine that the peak memory estimate is greater than a threshold associated with the virtual warehouse. In an example, the aforementioned aspect may correspond to the resource estimation 304.

In some aspects, the processing device may identify a subset of the input data set based on the determination, where training the ML model may include training the ML model based on the subset of the input data set. In an example, the aforementioned aspect may correspond to the resource estimation 304.

In some aspects, the processing device may featurize, based on the data query, the input data set, and training the ML may include training the ML model based on the featurized input data set. In an example, the aforementioned aspect may correspond to the featurization 306.

In some aspects, the processing device may partition, based on the data query, the input data set into a first subset of the input data set and a second subset of the input data set. In an example, the first subset of the input data set may be or include the first training data set 240 and the second subset of the input data set may be or include the second training data set 242. In an example, the aforementioned aspect may correspond to the evaluation 310.

In some aspects, the processing device may train, based on the first subset of the input data set, a second ML model in the virtual warehouse. In an example, the aforementioned aspect may correspond to the evaluation 310. In an example, the second ML model may be or include the validation ML model 244.

In some aspects, the processing device may evaluate performance of the second ML model based on the second subset of the input data set. In an example, the aforementioned aspect may correspond to the evaluation 310.

In some aspects, the processing device may transmit, to the client, an indication of the performance of the second ML model. In an example, the indication of the performance of the second ML model may include or be associated with the visualization(s) 246. In an example, the aforementioned aspect may correspond to the evaluation 310.

In some aspects, the processing device may receive, from the client, a second data query referencing a data set of the database associated with the virtual warehouse. In an example, the second data query may be or include the second data query 250. In an example, the data set may be or include the unclassified data set 248. In an example, the aforementioned aspect may correspond to the prediction 312.

In some aspects, the processing device may assign, based on the second data query, a label to each item in the data set using the ML model. In an example, the aforementioned aspect may correspond to the prediction 312. In an example, assigning the label to each item in the data set using the ML model may generate the classified data set 258. In an example, each item in the data set is a row of a table or a view.

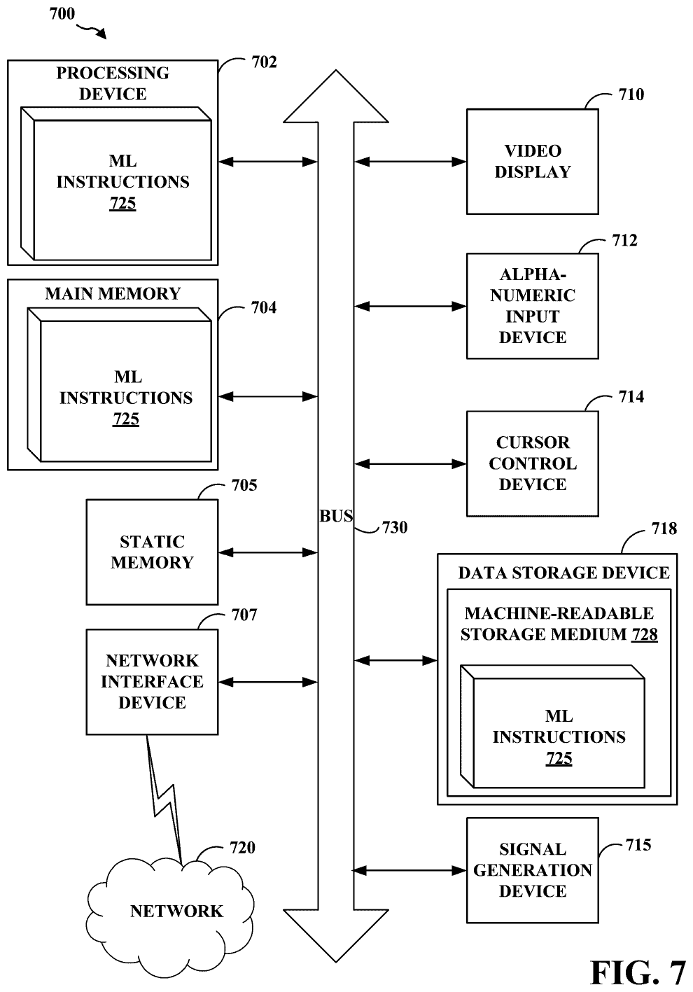

FIG. 7 illustrates a diagrammatic representation of a machine in the example form of a computer system 700 within which includes a set of instructions for causing the machine to perform any one or more of the methodologies discussed herein for classification (e.g., multiclass classification) with automated model selection, tuning, and training.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, the computer system 700 may be representative of a server.

The computer system 700 includes a processing device 702, a main memory 704 (e.g., read-only memory (ROM), flash memory, dynamic random access memory (DRAM), a static memory 705 (e.g., flash memory, static random access memory (SRAM), etc.), and a data storage device 718, which communicate with each other via a bus 730. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

The computer system 700 may further include a network interface device 707 which may communicate with a network 720. The computer system 700 also may include a video display unit 710 (e.g., a liquid crystal display (LCD) or a cathode ray tube (CRT)), an alpha-numeric input device 712 (e.g., a keyboard), a cursor control device 714 (e.g., a mouse), and an acoustic signal generation device 715 (e.g., a speaker). In one embodiment, the video display unit 710, the alpha-numeric input device 712, and the cursor control device 714 may be combined into a single component or device (e.g., an LCD touch screen).

The processing device 702 represents one or more general-purpose processing devices such as a microprocessor, a central processing unit (CPU), or the like. More particularly, the processing device 702 may be a complex instruction set computing (CISC) microprocessor, a reduced instruction set computer (RISC) microprocessor, a very long instruction word (VLIW) microprocessor, or a processor implementing other instruction sets, or processors implementing a combination of instruction sets. The processing device 702 may also be one or more special-purpose processing devices, such as an application specific integrated circuit (ASIC), a field programmable gate array (FPGA), a digital signal processor (DSP), network processor, or the like. The processing device 702 is configured to execute ML instructions 725, for performing the operations and steps discussed herein. For instance, the ML instructions 725 may include instructions for receiving, from a client, a data query referencing an input data set of a database associated with a virtual warehouse. The ML instructions 725 may further include instructions for allocating an amount of memory of the virtual warehouse to be used to train a machine learning (ML) model based on the input data set and a peak memory estimate, wherein the peak memory estimate is based on a heuristic. The ML instructions 725 may further include instructions for training, based on the input data set and the data query, the ML model in the virtual warehouse using the amount of memory.

The computer system 700 may include a data storage device 718. The data storage device 718 may include a machine-readable storage medium 728. The machine-readable storage medium 728 may store the ML instructions 725 (e.g., software) embodying any one or more of the methodologies of functions described herein. The ML instructions 725 may also reside, completely or at least partially, within the main memory 704 or within the processing device 702 during execution thereof by the computer system 700; the main memory 704 and the processing device 702 also constituting machine-readable storage media. The ML instructions 725 may further be transmitted or received over the network 720 via the network interface device 707.

The machine-readable storage medium 728 may also be used to store instructions to perform the methods described herein. While the machine-readable storage medium 728 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “receiving,” “routing,” “granting,” “determining,” “publishing,” “providing,” “designating,” “encoding,” “transmitting,” “allocating,” “training,” “generating,” “validating,” “performing,” “estimating,” “reperforming,” “identifying,” “featurizing,” “partitioning,” “evaluating,” “assigning,” “classifying,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned (including via virtualization) and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams or flow diagrams, and combinations of blocks in the block diagrams or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A system, comprising:
a memory; and
a processing device operatively coupled to the memory, the processing device to:
receive, from a client, a data query referencing an input data set of a database associated with a virtual warehouse;
allocate an amount of memory of the virtual warehouse to be used to train a machine learning (ML) model based on the input data set and a peak memory estimate, wherein the peak memory estimate is based on a heuristic; and
train, based on the input data set and the data query, the ML model in the virtual warehouse using the amount of memory.

2. The system of claim 1, wherein the data query is a structured query language (SQL) query, wherein to allocate the amount of memory, the processing device is to allocate the amount of memory based on the SQL query, and wherein to train the ML model, the processing device is to train the ML model based on the SQL query.

3. The system of claim 1, wherein the ML model is a classification model trained to classify a data set.

4. The system of claim 1, wherein the processing device is further to:
validate, based on the data query, the input data set, wherein to train the ML model, the processing device is to train the ML model based on the validated input data set.

5. The system of claim 4, wherein to validate the input data set, the processing device is to perform a set of validation steps on the input data set, and wherein the processing device is further to:
determine that a validation step in the set of validation step has failed;
transmit, to the client, an indication of the failed validation step;
receive, from the client, an indication of a correction to the input data set based on the indication of the failed validation step; and
reperform the validation step on the corrected input data set.

6. The system of claim 4, wherein to validate the input data set, the processing device is to validate at least one of: column types of the input data set, a size of the input data set, or an entirety of the input data set.

7. The system of claim 1, wherein the processing device is further to:
generate the peak memory estimate based on the heuristic, wherein the heuristic comprises:
a first set of factors comprising a number of rows of the input data set,
a second set of factors comprising the number of rows of the input data set, a number of columns of the input data set, and an amount of input memory, and
a third set of factors comprising the number of rows of the input data set, the number of columns of the input data set, the amount of the input memory, and a number of classes of the input data set.

8. The system of claim 7, wherein to generate the peak memory estimate, the processing device is to generate the peak memory estimate based on a combination of the first set of factors, the second set of factors, and the third set of factors.

9. The system of claim 1, wherein the processing device is further to:
determine that the peak memory estimate is greater than a threshold associated with the virtual warehouse; and
identify a subset of the input data set based on the determination, wherein to train the ML model, the processing device is to train the ML model based on the subset of the input data set.

10. The system of claim 1, wherein the processing device is further to:
featurize, based on the data query, the input data set, wherein to train the ML model, the processing device is to train the ML model based on the featurized input data set.

11. The system of claim 1, wherein the processing device is further to:
partition, based on the data query, the input data set into first subset of the input data set and a second subset of the input data set;
train, based on the first subset of the input data set, a second ML model in the virtual warehouse;
evaluate performance of the second ML model based on the second subset of the input data set; and
transmit, to the client, an indication of the performance of the second ML model.

12. The system of claim 1, wherein the processing device is further to:
receive, from the client, a second data query referencing a data set of the database associated with the virtual warehouse; and
assign, based on the second data query, a label to each item in the data set using the ML model.

13. A method, comprising:
receiving, from a client, a data query referencing an input data set of a database associated with a virtual warehouse;
allocating, by a processing device, an amount of memory of the virtual warehouse to be used to train a machine learning (ML) model based on the input data set and a peak memory estimate, wherein the peak memory estimate is based on a heuristic; and
training, based on the input data set and the data query, the ML model in the virtual warehouse using the amount of memory.

14. The method of claim 13, wherein the data query is a structured query language (SQL) query, wherein allocating the amount of memory is based on the SQL query, and wherein training the ML model is based on the SQL query.

15. The method of claim 13, further comprising:
generating the peak memory estimate based on the heuristic, wherein the heuristic comprises:
a first set of factors comprising a number of rows of the input data set,
a second set of factors comprising the number of rows of the input data set, a number of columns of the input data set, and an amount of input memory, and
a third set of factors comprising the number of rows of the input data set, the number of columns of the input data set, the amount of the input memory, and a number of classes of the input data set.

16. The method of claim 15, wherein generating the peak memory estimate based on the heuristic comprises generating the peak memory estimate based on a combination of the first set of factors, the second set of factors, and the third set of factors.

17. A non-transitory computer-readable medium having instructions stored thereon which, when executed by a processing device, cause the processing device to:
receive, from a client, a data query referencing an input data set of a database associated with a virtual warehouse;
allocate, by the processing device, an amount of memory of the virtual warehouse to be used to train a machine learning (ML) model based on the input data set and a peak memory estimate, wherein the peak memory estimate is based on a heuristic; and
train, based on the input data set and the data query, the ML model in the virtual warehouse using the amount of memory.

18. The non-transitory computer-readable medium of claim 17, wherein the data query is a structured query language (SQL) query, and wherein to allocate the amount of memory, the instructions, when executed by the processing device, cause the processing device to allocate the amount of memory based on the SQL query, and wherein to train the ML model, the instructions, when executed by the processing device, cause the processing device to train the ML model based on SQL query.

19. The non-transitory computer-readable medium of claim 17, wherein the instructions, when executed by the processing device, cause the processing device further to:
generate the peak memory estimate based on the heuristic, wherein the heuristic comprises:
a first set of factors comprising a number of rows of the input data set,
a second set of factors comprising the number of rows of the input data set, a number of columns of the input data set, and an amount of input memory, and
a third set of factors comprising the number of rows of the input data set, the number of columns of the input data set, the amount of the input memory, and a number of classes of the input data set.

20. The non-transitory computer-readable medium of claim 19, wherein to generate the peak memory estimate based on the heuristic, the instructions, when executed by the processing device, cause the processing device to generate the peak memory estimate based on a combination of the first set of factors, the second set of factors, and the third set of factors.
